(19) United States
(12) Patent Application Publication
(10) Pub. No.: US 2013/0024191 A1
(43) Pub. Date: Jan. 24, 2013

(54) AUDIO COMMUNICATION DEVICE, METHOD FOR OUTPUTTING AN AUDIO SIGNAL, AND COMMUNICATION SYSTEM

(71) Applicants: Robert Krutsch, Targu Jiu (RO); Radu D. Pralea, Bucharest (RO)

(72) Inventors: Robert Krutsch, Targu Jiu (RO); Radu D. Pralea, Bucharest (RO)

(73) Assignee: FREESCALE Semiconductor, Inc., Austin, TX (US)

(21) Appl. No.: 13/635,214

(22) PCT Filed: Apr. 12, 2010
(86) PCT No.: PCT/IB2010/051569

§ 371 Date: Sep. 14, 2012

(51) Int. Cl. G10L 19/04; G10L 19/02

(52) U.S. Cl. 704/205; 704/219; 704/E19.023; 704/E19.01

(57) ABSTRACT

An audio communication device comprises an input connectable to a narrowband audio signal source. The input can receive a narrowband audio signal having a first bandwidth. An extraction unit is connected to the input and arranged to extract a plurality of narrowband parameters from the narrowband audio signal. An extrapolation unit is connected to receive the plurality of narrowband parameters and arranged to generate a plurality of wideband parameters from the plurality of narrowband parameters. The extrapolation unit comprises one or more adaptive neuro-fuzzy inference system modules. The device further comprises a synthesis unit connected to receive the plurality of wideband parameters and arranged to generate, using the wideband parameters, a synthesized wideband audio signal having a second bandwidth wider than the first bandwidth. And the device comprises an output connectable to an acoustic transducer arranged to output for humans perceptible acoustic signals, for providing said synthesized wideband audio signal to the acoustic transducer.

### FIELD OF THE INVENTION

This invention relates to an audio communication device, a method for outputting audio signals, a communication system, and a computer program.

### BACKGROUND OF THE INVENTION

A communication system may for example be used for communicating audio signals between a sender and a receiver. Generally, a signal is any time-varying quantity, for example a current or voltage level that may vary over time. It should be noted that time-variation of a quantity may include zero variation over time. An audio signal represents a for a human, audible acoustic signal, for example music or speech, for example as electrical or optical signals.

A communication channel allows communication of signals having a maximum bandwidth not larger than the available channel bandwidth. A signal such as a speech signal comprises a variety of frequencies. Bandwidth of a signal is given by the range or width of a frequency spectrum of the signal between its lowest and highest frequency. Bandwidth of a speech signal is determined by human anatomy. However, available channel bandwidth may be narrow and may not allow for transmission of a wideband speech signal containing the complete spectrum of a speech signal. For example, one of the reasons for poor audio quality of telephone network systems is the limited bandwidth that is provided. Speech has perceptually significant energy in the 85-8000 Hz (Hertz) range. Frequency components above 3400 Hz are very important for speech intelligibility. However when a speech signal passes through a phone channel it is band-limited to about 300-3400 Hz. This limitation leads to reduced speech quality and intelligibility which may for example make it difficult to distinguish similar voices over the telephone.

Bandwidth extension comprises an estimation of the wideband signal from an available narrowband signal and is usually based on extrapolation of a set of parameters of the limited band to the wider band based on statistical data. This may be implemented using, for example, hidden Markov Models (HMMs), neural networks or codebooks, which require many computation steps.

In EP 1 350 243 A2 a speech bandwidth extension method is shown wherein a narrowband speech signal is analyzed and a synthesized lower frequency-band signal generated from extracted parameters is combined with a signal that is derived via up-sampling from the narrowband speech signal. Parameters are extracted using codebooks and minimization of energy based metrics.

In US 2009/0201983 Al an apparatus for estimating high-band energy in a bandwidth extension system is shown. A narrowband signal is analyzed and filter coefficients are extracted and replicated in an upper band in order to introduce only little distortion.

### SUMMARY OF THE INVENTION

The present invention provides an audio communication device, a method for outputting audio signals, a communication system, and a computer program product as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically shows a block diagram of an example of an embodiment of an audio communication device.

FIG. 2 schematically shows diagrams of examples of bell-shaped membership functions.

FIG. 3 schematically shows a diagram of a prior art example of an adaptive neuro-fuzzy inference system module.

FIG. 4 schematically shows a block diagram of an example of a set of adaptive neuro-fuzzy inference system modules.

FIG. 5 schematically shows a block diagram of an example of a voice classification module.

FIG. 6 schematically shows a block diagram of an example of a combined excitation signal and spectral envelope extraction.

FIG. 7 schematically shows a diagram of an example of a method for outputting audio signals.

FIG. 8 schematically shows speech signal spectrograms for an example sentence according to an embodiment of an audio communication device.

FIG. 9 schematically shows a block diagram of an example of an embodiment of a communication system.

### DETAILED DESCRIPTION OF THE PREFERRED EMBODIMENTS

Because the illustrated embodiments of the present invention may for the most part, be implemented using electronic components and circuits known to those skilled in the art, details will not be explained in any greater extent than that considered necessary as illustrated, for the understanding and appreciation of the underlying concepts of the present invention and in order not to obfuscate or distract from the teachings of the present invention.

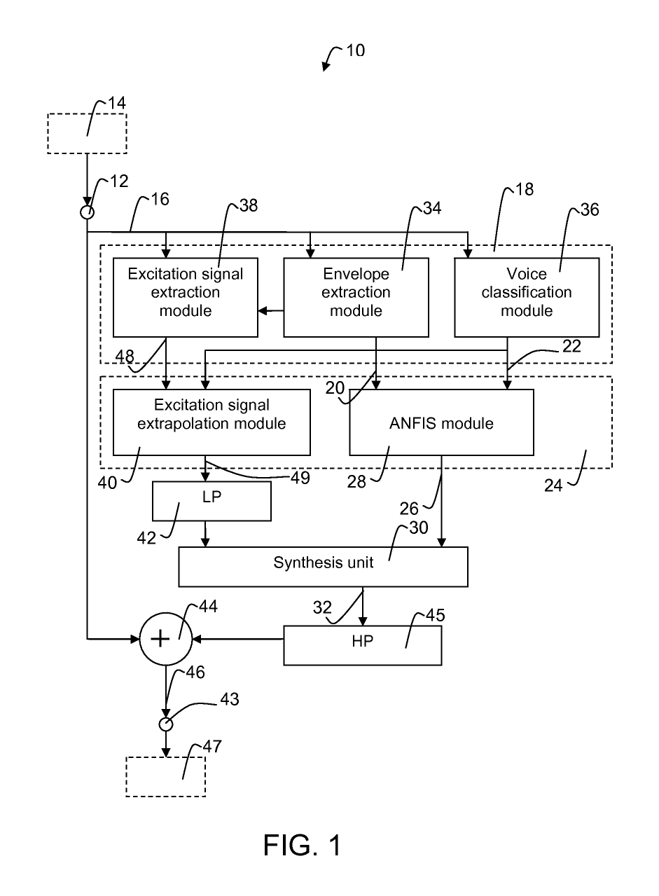

Referring to FIG. 1, a block diagram of an example of an embodiment of an audio communication device 10 is schematically shown. The audio communication device 10 may comprise an input 12 which in this example is connected to a narrowband audio signal source 14. The input 12 can receive a narrowband audio signal 16 having a first bandwidth from the source 14. An extraction unit 18 is connected to the input 12 and arranged to extract a plurality of narrowband parameters 20, 22 from the narrowband audio signal 16. An extrapolation unit 24 is connected to receive the plurality of narrowband parameters 20, 22 and arranged to generate a plurality of wideband parameters 26 from the plurality of narrowband parameters. It should be noted that narrowband parameters 20, 22 are parameters characterizing the narrowband audio signal 16.

Extracting a plurality of parameters may refer to determining, for a signal or signal frame, parameter values corresponding to the currently analyzed signal or signal frame.

The extrapolation unit comprises in this example one or more adaptive neuro-fuzzy inference system (ANFIS) modules 28. The device 10 further comprises a synthesis unit 30 connected to receive the plurality of wideband parameters 26 and arranged to generate, using the wideband parameters, a synthesized wideband audio signal 32 having a second bandwidth wider than the first bandwidth.

The device comprises an output 43, which in this example is connected to an acoustic transducer 47 arranged to output for humans perceptible acoustic signals, for providing said synthesized wideband audio signal to the acoustic transducer 47.

It should be noted that the synthesized wideband audio signal may be provided directly to the acoustic transducer 47 or via intermediate devices such as for example a filter device or mixing unit 44 for providing the synthesized wideband audio signal as part of a mixer output signal comprising additional signal components.

As explained below in more detail, the presented device 10 may allow for generating a wideband audio signal by using the information contained in the narrowband audio signal 16. It may especially allow for estimation of the high part of the spectrum, based on the information in the 300-3400 Hz band, i.e. may allow for providing high quality speech to users or subscribers without modifying an existing communication infrastructure.

The audio communication device 10 may for example be implemented as an integrated circuit. The device 10 may for example be implemented using electric or electronic circuits such as logic gates interconnected to perform specialized logic functions and/or other specialized circuits or may be implemented in a programmable logic device or may comprise program instructions being executed by one or more processing devices.

The narrowband audio signal source 14 may be any audio signal source through which an original wideband audio signal is provided with only a fraction of the original (wideband) frequency spectrum of the acoustic signal represented by the audio signal. The bandwidth of a narrowband signal is smaller than the bandwidth of the original acoustic signal. The narrowband audio signal source 14 may for example be a telephone line or any other communication channel providing only a limited channel bandwidth. Also, the bandwidth limitation may for example be introduced at a sender-side by using bandwidth limited devices such as bandwidth limited microphones.

The narrowband audio signal 16 may be provided as a sequence of signal frames, each having a certain duration or length in time. Parameter extraction, extrapolation and synthesizing may then be performed for some or each of the signal frames. The duration may be any duration such as for example 10 milliseconds (ms), 20 ms or 30 ms. For example, due to the limited variation of speech-signals, a frame duration of 20 ms for a speech signal may provide reliable extracted parameter values and may allow for tracking changes of the input signal.

Still referring to FIG. 1, the narrowband audio signal 16 is provided to extraction unit 18. The extraction unit 18 may extract any suitable parameter from the narrowband signal 16, such as the type of audio (voiced, not voiced for instance), the signal envelope, the excitation or any other suitable parameter. In the shown example, extraction unit 18 comprises, for example, excitation signal extraction module 38, envelope extraction module 34 and voice classification module 36.

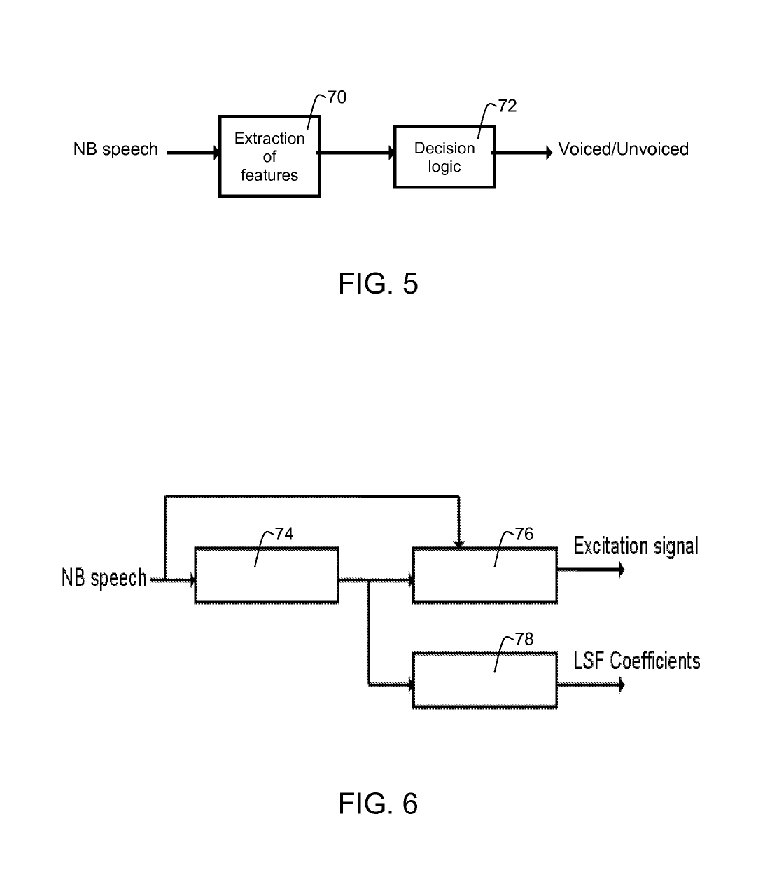

Referring to FIG. 5, a block diagram of an example of a voice classification module 36 is configured to determine at least one voice classification parameter 22. The voice classification parameter may be, e.g., a voiced/unvoiced identifier.

For this, the voice classification module may comprise a feature extraction block 70 connected to a decision logic block 72 comprising for example means such as logic circuitry for determining the voiced/unvoiced identifier. The feature extraction block 70 may receive the narrowband (NB) speech signal or frame and may be configured to determine for example an autocorrelation ratio R and/or spectral flatness Sf or derivative of the spectral flatness dSf, wherein for example a high R or low Sf may indicate a voiced signal frame.

$$R = \frac{{\sum }_{i = 1}^{N} {x}_{i}^{2}}{N} / \frac{{\sum }_{i = 1}^{N - 1} {x}_{i} {x}_{i + 1}}{N - 1} , N = number of samples in a frame$$

xᵢ may be an input sample of a digital input narrowband audio signal.

$$Sf = {\prod }_{i = 1}^{N / 2} {( \vert FFT ( x , N ) \vert )}^{\frac{2}{N}} / ( {\sum }_{i = 1}^{N / 2} ( \vert FFT ( x , N ) \vert ) / ( N / 2 ) )$$

wherein FFT is the fast Fourier transform.

Voiced and unvoiced clusters may be delimited from the multidimensional spaces of features based on thresholds elected after a series of tests on speech signals from a variety of speakers, for example of different nationalities.

The voice classification module 36 may be adapted to provide a voiced/unvoiced identifier. In another embodiment, the voice classification module 36 may also provide for example phoneme type classification into for example fricatives and vowels.

The extraction unit 18 of the audio communication device 10 may comprise an excitation signal extraction module 38 arranged to receive the narrowband audio signal 16 and to provide a narrowband excitation signal. The sound source or excitation signal may for example often be modeled as a periodic impulse train, for voiced speech, or white noise for unvoiced speech.

Referring now to FIG. 6, a block diagram of an example of a combined excitation signal and spectral envelope extraction is schematically shown. In order to extract excitation signal and for example LSF coefficients from a narrowband speech signal, LPC coefficients may be determined using for example Levinson or Levinson-Durbin recursion 74. A prediction filter 76 may then provide the excitation signal from a narrowband speech signal and an output of the recursion block 74. For provision of LSF coefficients, an LPC to LSF conversion block 78 may be used.

Referring back to FIG. 1, the extraction unit 18 may comprise an envelope extraction module 34 arranged to receive the narrowband audio signal 16 and arranged to extract a plurality of envelope parameters 20 from said narrowband audio signal 16. An envelope may be a spectral envelope. The extraction unit 18 may for example be directly connected to the input 12 of the audio communication device 10. The envelope extraction module may for example be arranged to extract and provide linear predictive coding (LPC) coefficients for representing a spectral envelope of a received speech signal, using information of a linear predictive model.

In an embodiment of the audio communication device 10, Line Spectral Frequencies (LSF) may be calculated to represent the Linear Prediction Coefficients (LPC). The plurality of envelope parameters 20 may comprise a plurality of line spectral frequency coefficients for the narrowband audio signal. It may also comprise the signal gain. Thereby, e.g. sensitivity to quantization noise may be improved.

Instead, or additionally, other features of the narrowband audio signal 16 may be extracted, for example cepstral coefficients or mel frequency cepstral coefficients (MFCCs). The plurality of narrowband parameters 20, 22 may comprise the plurality of envelope parameters 20 and other characteristic signal parameters such as for example a voiced/unvoiced identifier.

Still referring to FIG. 1, the extracted narrowband parameters 20, 22, 48 are inputted to the extrapolation unit 24. The extrapolation unit 24 may extrapolate the narrowband parameters 20, 22, 48 in any manner suitable for the specific implementation to obtain any suitable type of wideband parameters. In the shown example, extrapolation unit 24 includes e.g. excitation signal extrapolation module 40 in addition to ANFIS module 28 to generate a wideband excitation signal 49. At least some of the narrowband parameters 20, 22 may be provided to one or a set of ANFIS modules 28 of the extrapolation unit 24.

An adaptive neuro-fuzzy inference system or adaptive-network-based fuzzy inference system (ANFIS) may refer to a fuzzy inference system implemented in the framework of adaptive networks, as described for example in Jang, “ANFIS: Adaptive-Network-Based Fuzzy Inference System”, IEEE Transactions on Systems , Man, and Cybernetics, Vol. 23, No. 3, May/June 1993 or Jang, Sun, “Neuro-Fuzzy Modeling and Control”, The proceedings of the IEEE, Vol. 83, No. 3, pp. 378-406, March 1995. An ANFIS system may provide an input-output mapping based on both human knowledge (in the form of fuzzy if-then rules) and stipulated input-output data pairs. This non-linear mapping has been optimized for controlling highly complex systems such as power plant control, for example when a mathematical model of a plant is not easily obtainable. Here such ANFIS structures may be applied in a completely different environment of an audio communication device 10 and may be used for determining wideband audio signal parameters 26, for example of human speech, with only having narrowband parameters 20, 22 available, and without having an exact mathematical model available. The ANFIS modules 28 implemented in the shown audio communication device 10 may for example be of first order Sugeno type and membership functions μ_{A1}, μ_{A2}, μ_{B1} and μ_{B2} may be any continuous and piecewise differentiable function and may for example be bell shaped:

$${μ}_{{A}_{i}} ( x ) = exp ( - {[ {( \frac{x - {c}_{i}}{{a}_{i}} )}^{2} ]}^{{b}_{i}} ) , \\ \{ {a}_{i} , {b}_{i} , {c}_{i} \} = parameter set used to shape the membership function .$$

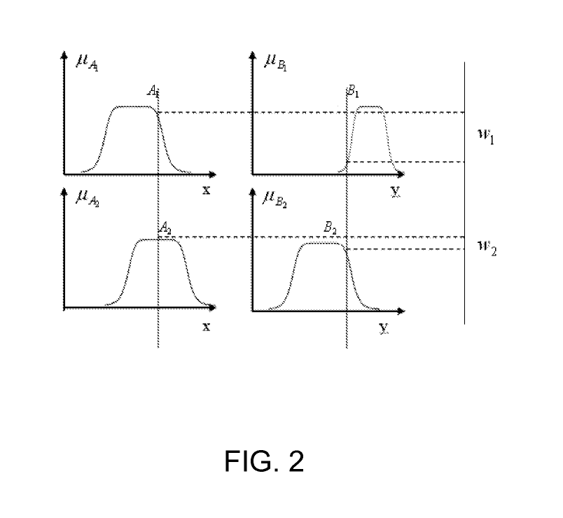

Referring now to FIG. 2, as an example, diagrams of examples of bell-shaped membership functions of a two-input x and y first-order Sugeno type fuzzy model with two rules are shown: IF x is A1 and y is B1 then f₁=p₁·x+q₁·y+r₁; and IF x is A2 and y is B2 then f₂=p₂·x+q₂·y+r₂.

An output function f may be given by f=(w₁·f₁+w₂·f₂)/(w₁+w₂), with firing strengths w₁ and w₂ as indicated in FIG. 2.

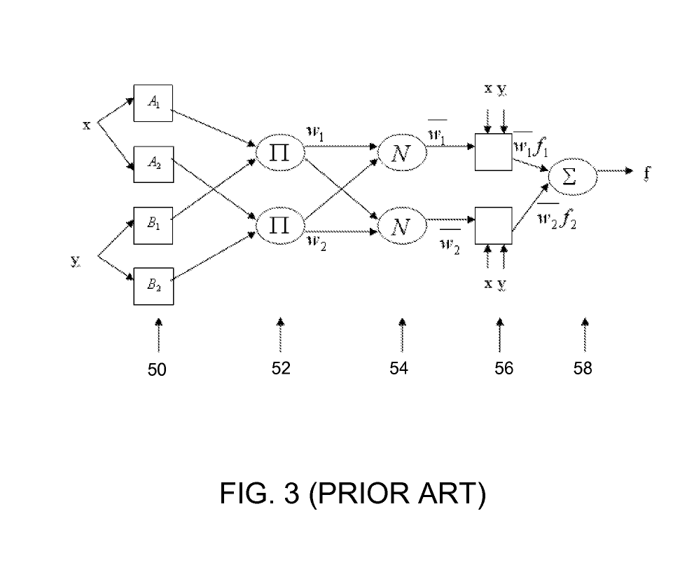

Referring also to FIG. 3, a diagram of a prior art example of an adaptive neuro-fuzzy inference system (ANFIS) module is shown, implementing a two-input x and y first-order Sugeno type fuzzy model with two rules as described above. Although the shown example is based on an implementation of a set of two rules, rule sets for parameter extrapolation may comprise more than two, for example 10 or 60 or 80 rules, typically from 20 to 80 rules, dependent on the importance of the parameter extrapolated from narrow-band to wide band. The structure of the inference models may then be obtained by applying subtractive clustering to avoid exponential growth in model complexity.

For narrowband line spectral frequency (LSF) input values, further conditions may for example be exploited when constructing the ANFIS modules: Generated wideband LSF have to be in a range [0 π] and have to be ordered.

As shown in this example, an ANFIS module may receive input narrowband parameter values x and y. Every node i in a first layer 50 may be an adaptive node with node output μ_{A1}, μ_{A2}, μB1 and μ_{B2}, and A1, A2, B1 and B2 being fuzzy sets associated with this node. Every node in a second layer 52 may be a fixed node labelled π for multiplying the incoming signals from the first layer and may output firing strengths w₁ and w₂. Every node in a third layer 54 may be a fixed node labeled N. The shown nodes may calculate normalized firing strengths w̅₁̅ and w̅₂̅ as the ratio of the rule's firing strength to the sum of all rules' firing strengths. In a fourth layer 56 node functions w̅₁̅·f1 and w̅₂̅·f2 may be calculated, whereas in a fifth layer 58 the overall output of the ANFIS module may be calculated as a summation of all incoming signals from the fourth layer. Implementation of an ANFIS module may differ and may for example comprise less or more than 5 layers.

ANFIS modules 28 may for example be optimized for extrapolation of the wideband parameters 26 relevant for high band estimation, which may be more important for human perception, but lower band (i.e. for example below 300 Hz) estimation may be performed as well.

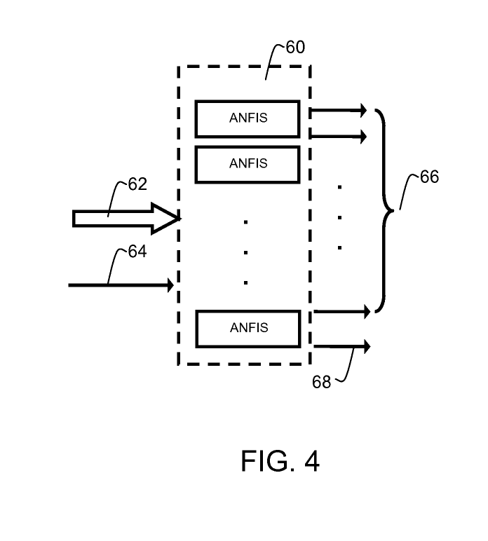

Referring to FIG. 4, block diagram of an example of a set 60 of adaptive neuro-fuzzy inference system (ANFIS) modules is shown. The one or more adaptive neuro-fuzzy inference system modules may be arranged to receive one or more of the narrowband parameters 62, 64 and to generate one or more wideband parameters 66, 68 from the one or more narrowband parameters 62, 64.

If more than one ANFIS module is used, narrowband parameters 62, 64 may be provided to the set of ANFIS modules for example in parallel. As shown, for example ten narrowband (NB) LSFs 62 and the extracted narrowband signal gain 64 may be applied to the set 60 of ANFIS modules and for example twenty wideband (WB) LSFs 66 and a wideband gain 68 may be determined. ANFIS modules may be trained using for example a hybrid method of training, such as a combination of a least squares algorithm and backpropagation. As an example, the training may be automatically performed based on speech databases such as for example the Restricted Languages Multilingual Speech Database 2002.

Referring again to FIG. 1, the extrapolation unit 24 may comprise an excitation extrapolation module 40 connected to receive the narrowband excitation signal 48 and arranged to generate a wideband excitation signal 49 from the narrowband excitation signal 48. In the shown extrapolation unit 24, extrapolation of the narrowband excitation signal 48 to a wideband excitation signal 49 may for example be achieved using spectral folding for unvoiced frames and single-side band modulation for voiced frames. In other embodiments, for example codebooks or band-pass modulated white noise excitation may be used.

The generated wideband excitation signal may be applied to the synthesis unit 30 directly or the spectrum of the generated wideband excitation signal 49 may be smoothed for example with a low pass filter 42 before applying to the synthesis unit 30.

Synthesis of an audio signal, e.g. a speech signal, comprises generating a new audio signal not directly from an input audio signal but based on parameters representing characteristics of the audio signal, such as the extrapolated wideband parameters 26 and the wideband excitation signal 49 in the shown example. The new audio signal may be a (re-)synthesized version of the analyzed input audio signal or, as shown here, of a signal sharing characteristics with the original (narrowband) input audio signal while providing additional properties, such as for example an extended bandwidth compared to the input signal.

Still referring to FIG. 1, the synthesis unit 30 may be arranged to receive the wideband excitation signal 49. The received wideband excitation signal 49 may be directly provided by the excitation signal extrapolation module 40 or a processed, such as e.g. low-pass 42 filtered, version thereof. Convolution of the wideband excitation signal with a filter response of a synthesis filter 30 based on the extrapolated wideband parameters 26 may then help generate a high quality synthesized wideband signal 32.

At least one of the one or more adaptive neuro-fuzzy inference system modules 28 may be arranged to adapt at least one decision rule and at least one parameter of the one or more adaptive neuro-fuzzy inference system modules 28 to human perception of the synthesized wideband audio signal 32.

For generation of a bandwidth extended high quality wideband audio signal 46, the audio communication device 10 may comprise a mixing unit 44 arranged to receive the narrowband audio signal 16 and the synthesized wideband audio signal 32 and arranged to generate a wideband audio signal 46 from the narrowband audio signal 16 and the synthesized wideband audio signal 32. A mixer may be any signal mixing device. Mixing the narrowband signal and the synthesized wideband signal may for example comprise summation of the signals. Before applying the synthesized wideband signal 32 to the mixing unit 44, a high-pass filter 45 may be applied in order to limit the influence of the synthesized signal only to the estimated high band where no narrowband signal components are available.

In an embodiment of the audio communication device comprising a mixing unit for mixing the synthesized wideband audio signal with the input narrowband audio signal, at least one ANFIS module 28 may be arranged to adapt at least one decision rule and at least one parameter of the one or more adaptive neuro-fuzzy inference system modules 28 to human perception of the wideband audio signal generated by mixing, which comprises the synthesized wideband signal.

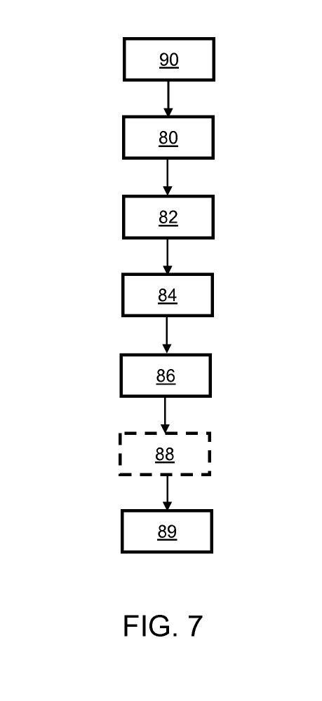

Referring now to FIG. 7, a diagram of an example of a method for outputting audio signals is schematically shown. The illustrated method allows implementing the advantages and characteristics of the described audio communication device as part of a method for outputting audio signals.

The method may comprise receiving 80 a narrowband audio signal; extracting 82 a plurality of narrowband parameters of the narrowband signal; extrapolating 84 a plurality of wideband parameters of a wideband signal from the narrowband parameters by applying the narrowband parameters to at least one adaptive neuro-fuzzy inference system; generating 86 a synthesized wideband audio signal using the wideband parameters, the synthesized wideband signal having a second bandwidth wider than the first bandwidth; and outputting 89 the synthesized wideband audio signal.

The extrapolating 84 may comprise generating at least one of the one or more characteristic parameters of the wideband audio signal by applying one or more characteristic parameters of the narrowband audio signal to at least one adaptive neuro-fuzzy inference system (ANFIS) module.

Further, the shown method for outputting audio signals may comprise mixing 88 the narrowband audio signal and the synthesized wideband audio signal and generating a wideband audio signal from the narrowband audio signal and the synthesized wideband audio signal. In an embodiment of the method, this may include high-pass filtering the synthesized wideband audio signal before mixing with the narrowband audio signal.

The extracting 82 may comprise classifying the narrowband audio signal, for example by determining at least one voice classification parameter. And it may comprise extracting a narrowband excitation signal. The extrapolating 84 may comprise generating a wideband excitation signal from the narrowband excitation signal.

In an embodiment, the method for outputting audio signals may comprise 90 adapting at least one decision rule and at least one parameter of the at least one adaptive neuro-fuzzy inference system to human perception of the synthesized wideband audio signal. If the method comprises a step of mixing 88 the synthesized wideband audio signal with the input narrowband audio signal, adapting at least one decision rule and at least one parameter of the at least one adaptive neuro-fuzzy inference system to human perception of the synthesized wideband audio signal may refer to human perception of the wideband audio signal generated by mixing, which comprises the synthesized signal.

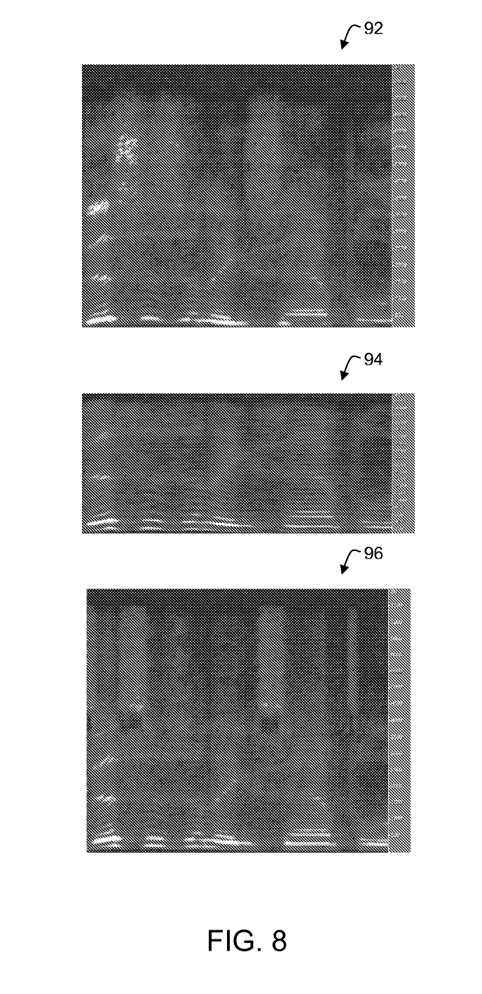

Referring to FIG. 8, speech signal spectrograms 92, 94, 96 for an example sentence according to an embodiment of an audio communication device are shown. A spectrogram is an image that shows how the spectral density of a signal varies with time, i.e. in the image plane frequency is displayed over time and spectral density is indicated by different grayscale levels. Image 92 shows a spectrogram of an original wideband speech signal in the range of 0 to 8000 Hz, whereas image 94 shows a narrowband version (0 to 4000 Hz) of the speech signal bandwidth limited by transfer through a telephone channel. Image 96 shows a wideband signal generated from the narrowband signal shown in image 94 according to the presented bandwidth extension. The extrapolated spectrum can be estimated very close to the original wideband audio signal spectrum.

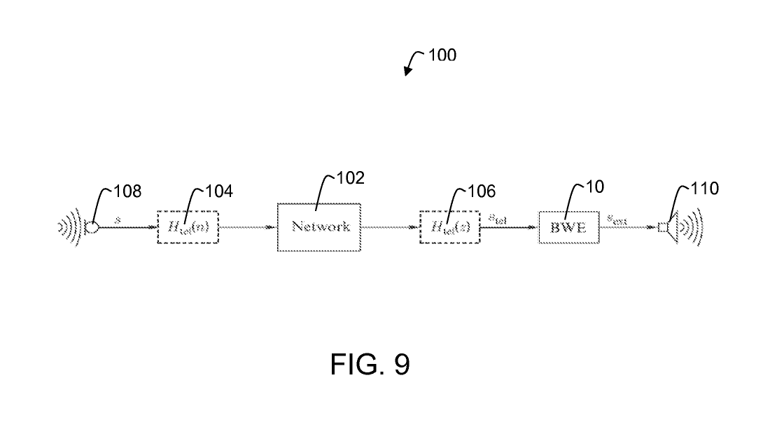

Referring now also to FIG. 9, a block diagram of an example of an embodiment of a communication system 100 is schematically shown. The communication system 100 may comprise an audio communication device 10 or may be adapted to perform a method as described above. The communication system may comprise a communication network 102 having a transfer function 104, 106 allowing only for bandwidth limited transmission of an audio or speech signal from a sender 108 to a receiver 110. The communication system 100 may for example be a telephone system. The shown audio communication device 10 (BWE: bandwidth extension) may for example be implemented as part of the telephone network infrastructure or it may be implemented as part of a telephone device. Since telephone networks are within the most widespread networks all over the world, a solution for extension of the limited bandwidth that does not require a massive change in network hardware is advantageous, especially from a cost point of view. As another example, the shown communication system 100 may be a narrowband radio communication system or a system that comprises narrowband sender-side communication equipment.

The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connections that transfers multiple signals serially or in a time multiplexed manner. Likewise, single connections carrying multiple signals may be separated out into various different connections carrying subsets of these signals. Therefore, many options exist for transferring signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, the shown ANFIS module structure may be implemented differently, using more or less layers. And units and modules of the audio communication device 10 may be merged or further separated as long as the same functionality can be achieved.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. For example, the audio communication device 10 may be implemented as a single integrated circuit. Alternatively, the examples may be implemented as any number of separate integrated circuits or separate devices interconnected with each other in a suitable manner. For example, the analysis or extraction unit 18 and the extrapolation unit 24 and the synthesis unit 30 may be implemented as separate integrated circuits.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While the principles of the invention have been described above in connection with specific apparatus, it is to be clearly understood that this description is made only by way of example and not as a limitation on the scope of the invention.

1. An audio communication device, comprising
an input connectable to a narrowband audio signal source, said input arranged to receive a narrowband audio signal having a first bandwidth;
an extraction unit connected to said input and arranged to extract a plurality of narrowband parameters from said narrowband audio signal;
an extrapolation unit connected to receive said plurality of narrowband parameters and arranged to generate a plurality of wideband parameters from said plurality of narrowband parameters, said extrapolation unit comprising one or more adaptive neuro-fuzzy inference system modules;
a synthesis unit connected to receive said plurality of wideband parameters and arranged to generate, using said wideband parameters, a synthesized wideband audio signal having a second bandwidth wider than said first bandwidth; and
an output connectable to an acoustic transducer arranged to output for humans perceptible acoustic signals, for providing said synthesized wideband audio signal to the acoustic transducer.

2. The audio communication device as claimed in claim 1, wherein said extraction unit comprises an envelope extraction module arranged to receive said narrowband audio signal and arranged to extract a plurality of envelope parameters from said narrowband audio signal.

3. The audio communication device as claimed in claim 2, wherein said plurality of envelope parameters comprises a plurality of line spectral frequency coefficients for said narrowband audio signal.

4. The audio communication device as claimed in claim 1, wherein said one or more adaptive neuro-fuzzy inference system modules are arranged to receive one or more of said narrowband parameters and to generate one or more wideband parameters from said one or more narrowband parameters.

5. The audio communication device as claimed in claim 1, wherein said extraction unit comprises a voice classification module arranged to receive said narrowband audio signal and to determine at least one voice classification parameter.

6. The audio communication device as claimed in claim 1, wherein said extraction unit comprises an excitation signal extraction module arranged to receive said narrowband audio signal and to provide a narrowband excitation signal.

7. The audio communication device as claimed in claim 6, wherein said extrapolation unit comprises an excitation extrapolation module connected to receive said narrowband excitation signal and arranged to generate a wideband excitation signal from said narrowband excitation signal.

8. The audio communication device as claimed in claim 7, wherein said synthesis unit is arranged to receive said wideband excitation signal.

9. The audio communication device as claimed in claim 1, comprising a mixing unit arranged to receive said narrowband audio signal and said synthesized wideband audio signal and arranged to generate a wideband audio signal from said narrowband audio signal and said synthesized wideband audio signal.

10. The audio communication device as claimed in claim 1, wherein at least one of said one or more adaptive neuro-fuzzy inference system modules is arranged to adapt at least one decision rule and at least one parameter of said one or more adaptive neuro-fuzzy inference system modules to human perception of said synthesized wideband audio signal.

11. The audio communication device as claimed in claim 1, wherein the audio communication device is implemented as an integrated circuit.

12. A method for outputting audio signals, comprising
receiving a narrowband audio signal having a first bandwidth;
extracting a plurality of narrowband parameters of said narrowband signal;
extrapolating a plurality of wideband parameters of a wideband signal from said narrowband parameters by applying said narrowband parameters to at least one adaptive neuro-fuzzy inference system;
generating a synthesized wideband audio signal using said wideband parameters, said synthesized wideband signal having a second bandwidth wider than said first bandwidth; and
outputting said synthesized wideband audio signal.

13. The method as claimed in claim 12, comprising mixing said narrowband audio signal and said synthesized wideband audio signal and generating a wideband audio signal from said narrowband audio signal and said synthesized wideband audio signal.

14. The method as claimed in claim 12, wherein said extracting comprises determining at least one voice classification parameter.

15. The method as claimed in claim 12, wherein said extracting comprises extracting a narrowband excitation signal.

16. The method as claimed in claim 15, wherein said extrapolating comprises generating a wideband excitation signal from said narrowband excitation signal.

17. The method as claimed in claim 12, comprising adapting at least one decision rule and at least one parameter of said at least one adaptive neuro-fuzzy inference system to human perception of said synthesized wideband audio signal.

18. A communication system, comprising an audio communication device claimed in claim 1.

19. A computer program product, comprising code portions for executing steps of a method as claimed in claim 12 when run on a programmable apparatus.
